(19) United States
(12) Patent Application Publication
(10) Pub. No.: US 2016/0094088 A1
(43) Pub. Date: Mar. 31, 2016

(54) LIGHTING UNIT HAVING ENERGY HARVESTING POWER MANAGEMENT SYSTEM

(71) Applicant: SENECO A/S, Hasselager (DK)

(72) Inventors: Lars Norgaard Bjorn, Ronde (DK); Dan Staerk, Arhus C (DK); Kaspar Raahede Aaroe, Hinnerup (DK); Mikkel Aunsbjerg Jakobsen, Arhus C (DK)

(73) Assignee: SENECO A/S, Hasselager (DK)

(21) Appl. No.: 14/891,115

(22) PCT Filed: May 15, 2014
(86) PCT No.: PCT/EP2014/059932

§ 371 Date: Nov. 13, 2015

(30) Foreign Application Priority Data
May 15, 2013 (DK) PA 2013 70265

(51) Int. Cl. H02J 9/06; H05B 37/02

(52) U.S. Cl. CPC H02J 9/061; H05B 37/0245; H05B 37/0227; H05B 37/0281

(57) ABSTRACT

The present invention relates to a light unit comprising a power management system being capable of delivering electrical power from a power generating unit of the light unit to an associated power distributing system, said power management system comprising a system controller adapted to deliver power to the power distributing system in accordance with a number of inputs to said system controller.

### FIELD OF THE INVENTION

The present invention relates to an energy harvesting power management system. More specifically, the invention relates to a system that can derive energy from external sources and deliver it to an external power grid.

### BACKGROUND OF THE INVENTION

Various so-called intelligent light units have been disclosed in the patent literature over the years. An example of such a light source is disclosed in WO 96/20369.

WO 96/20369 discloses how to intelligently power a lamp from a power grid and/or from a battery being charged from either a solar panel or the power grid.

It may be seen as an object of embodiments of the present invention to provide an intelligent light unit being capable of not only drawing power from the power grid but also providing excess power to the power grid.

### DESCRIPTION OF THE INVENTION

The above-mentioned object is complied with by providing, in a first aspect, a light unit comprising a power management system being capable of delivering electrical power from a power generating unit of the light unit to an associated power distributing system, said power management system comprising a system controller adapted to deliver power to the power distributing system in accordance with a number of inputs to said system controller.

The light unit may in principle be any kind of light unit, such as a street light. The light unit may be an isolated street light or a street light forming part of a network of street lights. This network of street lights may be interconnected a in manner so that for example control data or control data packages may be communicated between the street lights.

Moreover, the light unit may be capable of receiving electrical power from the associated power distributing system.

Even further the light unit may further comprise a power reservoir. In this scenario the system controller of the power management system may be capable of delivering power to, or drawing power from, the power reservoir and/or the power distributing system in accordance with said number of inputs to said system controller.

The power reservoir may comprise a battery. The associated power distribution system may comprise a power grid.

The number of inputs to the system controller may involve a plurality of inputs. The plurality of inputs may comprise information about a voltage, a current, a temperature and/or time.

The power generating unit of the light unit may be selected from the group consisting of: solar power, wind energy, thermal energy, kinetic energy, salinity gradients, vibration/mechanical energy, wave energy, RF energy, piezo-electric energy and electromagnetic energy.

As mentioned above, the light unit may form part of a street light.

In a second aspect, the present invention relates to a network comprising a plurality of light units according to the first aspect. The plurality of light units may be in communication with each other in a manner so that each of the light units may communicate with a least one other light unit, such as a neighboring light unit.

In a third aspect, the present invention relates to a method for delivering electrical power from a power generating unit of a light unit to an associated power distributing system, the method comprising the steps of providing a system controller, and operating the system controller so as to deliver power to the power distributing system in accordance with a number of inputs to said system controller.

The method may further comprise the step of operating the system controller so as to deliver power to, or drawing power from, a power reservoir of the light unit in accordance with said number of inputs to said system controller.

The number of inputs to the system controller may comprise information about a voltage, a current, a temperature and/or time.

Similar to the first aspect the power generating unit may be selected from the group consisting of: solar power, wind energy, thermal energy, kinetic energy, salinity gradients, vibration/mechanical energy, wave energy, RF energy, piezo-electric energy and electromagnetic energy.

Thus, the present invention relates to an arrangement that, among other features, can derive energy from external sources, such as solar power, wind energy, thermal energy, kinetic energy, salinity gradients, vibration/mechanical energy, wave energy, RF energy, piezo-electric energy, electromagnetic energy, and deliver it to an associated power distribution system, such as a power grid. Optionally energy may be stored in a battery or other energy storage device, cf. FIG. 1.

The stored energy can be used to power the internal system and/or an external device of the light unit, such as a light emitted device (LED).

The advantages of the energy harvesting power management system (EHPMS) is the ability to ensure that the energy used does not exceed the harvested energy by limiting the power output, and thereby securing power deliverance to the external or internal load even in periods where the system is not harvesting power.

Furthermore, the system itself can determine whether power usage is allowed which can be determined from an external or internal source, such as, but not limited to, light detector, photovoltaic, temperature sensor, vibration sensor, sound sensor, pressure sensor, moisture sensor, humidity sensor, motion detection sensor, PIR sensor, radar sensor, gyro sensor, ice detector, wind/airflow sensor etc. A time schedule may also be used to determine if power usage is allowed.

To additionally preserve power the EHPMS introduces a method of letting a detection mechanism that may be combined with a time schedule increase or decrease the output power during the allowed power usage period, and still securing the overall power deliverance during the allowed power usage period.

The EHPMS also utilizes a new method of maximum peak point tracking specially aimed towards increasing the power from rapidly changing power sources such as photovoltaic and others.

The EHPMS will also maintain the energy storage device if connected, by taking measures which may be temperature and voltage level into account. This ensures that the energy storage device is used within its specifications, and thereby the energy storage device lifetime is optimized.

The EHPMS may be fitted with a wired and or wireless communication module, so remote management and/or configuration and monitoring of the system(s) is possible. This utilizes the possibility to monitor the system and/or remotely control the system increasing the flexibility of the system usage.

More the communication can be used to exchange information between EHPMS' which may be from internal or external detection devices which may be a motion sensor, utilizing the possibility for one EHPMS to affect another EHPMS.

All of the above mentioned features can be individually enabled/disabled if preferred.

The present invention is exemplified by a photovoltaic battery charging system with an LED driver as output device in the following. The system may be fitted with an external detection device which may be a motion detector and LED's which luminous output may be increased when motion is detected. The photovoltaic produce energy that can be stored in an energy storing device which may be a battery during daytime, the LED's can produce light during the night time.

This setup is merely meant as an example of one type of configuration of the EHPMS, rather than limiting the usage of the EHPMS to this specific configuration.

### BRIEF DESCRIPTION OF THE DRAWINGS

The present invention will now described in further detail with reference to the accompanying figures where

FIG. 1 shows the principle of the EHPMS system, and

FIG. 2 shows an enhanced MPPT principle.

While the invention is susceptible to various modifications and alternative forms, specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

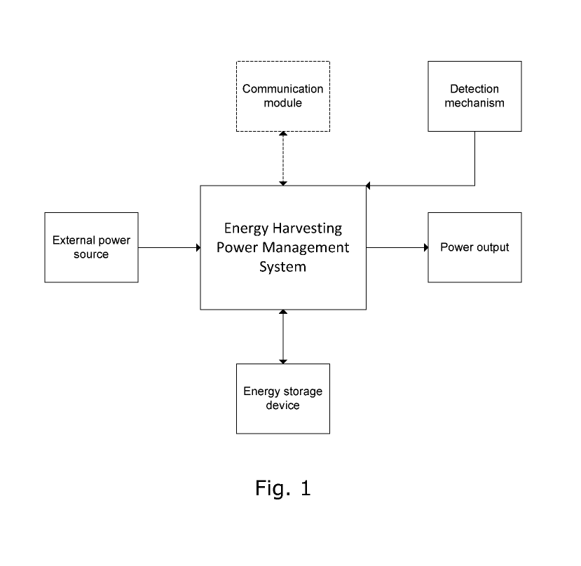

Referring now to FIG. 1 the present invention relates, in its broadest aspect, to an arrangement where a EHPMS is capable of guiding power from an external power source to an energy storage device or a power grid (power output) in response to one or more inputs from a detection mechanism. The EHPMS may optionally communicate with one or more other EHPMS' via a communication module.

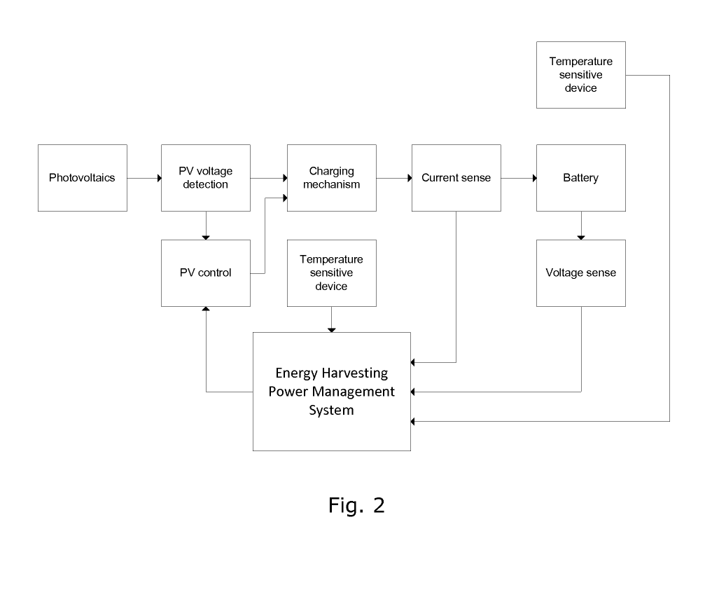

Reference will in the following be made to a photovoltaic (PV) arrangement as the one depicted in FIG. 2. This is, however, not to be understood as a limitation of the present invention to PV-based arrangements. Other types of external power source may be applicable as well.

### PV Battery Charging

When charging one or more batteries from a PV source an optimum use of the power from the PV is wanted in order to get the most efficient system.

Multiple methods of Maximum Peak Point Tracking (MPPT) already exists, while this principle consists of other segments combined with the MPPT in order to further increase the efficiency of the power at hand.

To increase the usage of the power from the PV's this principle includes the ability to rapidly adjusting the MPPT even with scattered clouds in the sky i.e. the amount of power delivered from the PV's is rapidly changing. A charging mechanism is used which may be a buck, boost, buck-boost, sepic, flyback, push-pull, half-bridge, full-bridge, cuk or other topologies. This charger may be current or voltage regulated, and may consist of a dedicated chip which may have a feedback loop.

The fast response of the MPPT of the charging mechanism could be obtained by directly forward feeding the PV's voltage into the feedback loop of the charging mechanism, cf. FIG. 2. This may be done with a voltage divider from the PV's buffered and inverted by an op-amp and fed into the feedback loop of the charging mechanism.

A temperature sensitive device may be placed close to or on the battery/batteries to ensure optimum charging of the battery/batteries. Another temperature sensitive device may be placed close to or on the charging mechanism to detect the state of the charging mechanism.

To measure the battery voltage a voltage sensing mechanism is used which may be a voltage divider. To measure the current flowing in and out of the battery a current sensing device is used which may be a shunt resistor.

The EHPMS will collect the data from the different inputs, and calculate the optimum power delivered to the battery. By monitoring the current fed to the battery and the battery voltage and controlling the output to the PV control, an optimum point of charging the battery can be found. This procedure may be repeated with very short intervals.

The optimum voltage and/or current fed to the battery is temperature dependent, by monitoring the temperature of the battery the EHPMS can calculate the optimum charge current and voltage.

The optimum charging temperature of the charging mechanism can also be found and corrected for by the EHPMS.

To ensure that the optimum charging peak is found by the EHPMS a “scan” of all or parts of different powers delivered to battery may be performed during the charging process.

### Optimization of Power Usage and Day/Nighttime Detection

The following describes methods to maximize the usage of the charged power to a photovoltaic-powered power management system or others.

The photovoltaic (PV), or other similar light sensitive devises can be used to determine the sunrise and the sunset—which can be used to determine the hours of daylight and the hours of nighttime i.e. whether the EHPMS' power output is switched on or off, in this case daytime=power output on, nighttime=power output off.

One or more PV-voltage level points can be set to determine whether the sun is up or the sun has set, i.e. if the PV-voltage level is above the trigger point the sun is categorized as up. Other devices to provide an input to determine whether the power output is switched off (daytime) or on (nighttime) may be light detector, temperature sensor, vibration sensor, sound sensor, pressure sensor, moisture sensor, humidity sensor, motion detection sensor, PIR sensor, radar sensor, gyro sensor, ice detector, wind/airflow sensor and others.

To prevent false sun-“state” (i.e. sun up or sun down) decisions, methods like hysteresis in the trigger points, averaging over time, minimum and or maximum length of determined daytime and nighttime and others may be used.

Other methods to determine the whether the power output is switched on or off may be a predefined time schedule which may have preset power output levels which may change during the nighttime (the entire predefined power output on time). Further the time schedule may define whether the external detection mechanism is active or not.

If it is preferred to be able to increase or decrease the output power at specific times during the nighttime, a method is described to determine the time of day from the sunrise and sunset. When knowing the length of the daytime and/or nighttime, and knowing if the previous night(s) were longer or shorter, a preinstalled function or table with dates and length of the day could be used to determine the time of day. With this information it is possible to increase and decrease the power for the load at different periods of the day.

The advance of the EHPMS method of determining the time of day over ex. an installed Real Time Clock (RTC) is the chance of the RTC to drift over time. Since the EHPMS determines the time of day based on the night length, the determining of the time of day can be made with very short intervals, and thereby minimizing the risk of time drift.

To help prevent the battery “dies” during nighttime, two or more battery levels/states could be implemented. By measuring the battery voltage level and or other battery conditions such as current draw, temperature etc. the overall battery condition can be determined.

A set of three battery states is described. The three states could be named “Battery Normal”, “Battery Low” and “Battery Drop Out”.
Battery Normal: This state is used when battery condition is good, and may be no restrictions to maximum battery output power allowed.
Battery Low: This state is used when battery condition is poor, and there may be restrictions to maximum battery output power allowed, to prolong the time before battery “dies”.
Battery Drop Out: This state is used when battery condition is critical, and there may be restrictions of, or zero battery output power allowed.

To ensure a known battery condition when installing the battery, a method of determining the initial battery state may be to fully discharge the battery until “Battery Drop Out” is reached, not until this state is reached is the battery allowed to be recharged.

When the sun state and the battery state are known, it is possible to determine the length of the nighttime and the power charged by the PV's during the daytime. Since the nighttime length does not differ much from one night to the next night, the previous nighttime length can be used to predict the upcoming nighttime length. To further improve the determination of the nighttime an average of two or more nights could be used.

Combined with the power charged, the maximum allowed average battery output power during the next nighttime can be determined. Combined with the battery states possibility to further reduce the maximum allowed battery output power a failsafe solution to ensure that the battery power is not fully used is presented.

### Detection Mechanism

If a detection mechanism which may be a motion detector, PIR sensor, light detector, temperature sensor, vibration sensor, sound sensor, microphone, pressure sensor, moisture sensor, humidity sensor, radar sensor, gyro sensor, ice detector, wind/airflow sensor and others is used to increase (or decrease) the output power from the EHPMS for a period of time, a method of calculating the new maximum allowed output power for the remaining nighttime is needed.

The method described uses the input from the detection mechanism to increase the power usage for a given time period as an example.

If the average maximum allowed battery output power is determined for the entire nighttime, an increase in output power for a given time period will decrease the remaining power available. To prevent that the battery “dies”, the method will calculate a new maximum allowable battery output power based on the remaining nighttime, and the power available. This procedure is repeated if another input from the detection mechanism is found i.e. another increase in output power for a given time period.

Another method could be to save the previous night(s) number of increases in power to estimate the average power of the next night including increases in power. If the EHPMS system does not use the allowed energy or uses too much, the system will look at the history of the allowed energy, and either increase or decrease the output power to insure a correct level of capacity—also over longer periods of time. This insures that the system doesn't get into a deadlock situation over time.

### Communication

If preferred the EHPMS may be fitted with a wired and or wireless communication module which allows the EHPMS to be remotely managed/configured/monitored, and further allows two or more EHPMS' to interchange information and affect each other.

All the above mentioned features and settings of the EHPMS may be remotely enabled/disabled and configured, increasing the flexibility of the system.

Further the state and data from the EHPMS may be remotely monitored via the wired and or wireless communication.

Additionally two or more EHPMS' can interchange information if a state or internal or external detection device is affected. This may be used to let one or more EHPMS' increase or decrease the power output of other EHPMS'.

As an example a number of EHPMS' may be able to communicate with each other, one or more is fitted with an external detection device which may be a motion detector, and one or more may be fitted with an external power load connected to the power output, which may be LED(s). When one or more of the external detection devices is affected, one or more of the other EHPMS' may increase or decrease their power outputs which also may be the case for the EHPMS which detection device is affected. This may be used in ex. street lights where the luminaries are dimmed when no motion is detected, when a motion is detected, one or more of the luminaries' lights up and illuminates the street in front of the object detected by the motion detector.

1. A light unit comprising a power management system being capable of delivering electrical power from a power generating unit of the light unit to an associated power distributing system, said power management system comprising a system controller adapted to deliver power to the power distributing system in accordance with a number of inputs to said system controller.

2. A light unit according to claim 1, further being capable of receiving electrical power from the power distributing system.

3. A light unit according to claim 1, further comprising a power reservoir, wherein the system controller of the power management system is capable of delivering power to, or drawing power from, the power reservoir and/or the power distributing system in accordance with said number of inputs to said system controller.

4. A light unit according to claim 3, wherein the power reservoir comprises a battery.

5. A light unit according to claim 1, wherein the associated power distribution system comprises a power grid.

6. A light unit according to claim 1, wherein the number of inputs to the system controller involves a plurality of inputs.

7. A light unit according to claim 6, wherein the plurality of inputs comprise information about a voltage, a current, a temperature and/or time.

8. A light unit according to claim 1, wherein the power generating unit is selected from the group consisting of: solar power, wind energy, thermal energy, kinetic energy, salinity gradients, vibration/mechanical energy, wave energy, RF energy, piezoelectric energy and electromagnetic energy.

9. A light unit according to claim 1, wherein said light unit forms part of a street light.

10. A network comprising a plurality of light units according to claim 1.

11. A method for delivering electrical power from a power generating unit of a light unit to an associated power distributing system, the method comprising the steps of
providing a system controller, and
operating the system controller so as to deliver power to the power distributing system in accordance with a number of inputs to said system controller.

12. A method according to claim 11, further comprising the step of operating the system controller so as to deliver power to, or drawing power from, a power reservoir of the light unit in accordance with said number of inputs to said system controller.

13. A method according to claim 12, wherein the number of inputs comprise information about a voltage, a current, a temperature and/or time.

14. A method according to claim 11, wherein the power generating unit is selected from the group consisting of: solar power, wind energy, thermal energy, kinetic energy, salinity gradients, vibration/mechanical energy, wave energy, RF energy, piezoelectric energy and electromagnetic energy.
